(19) United States
(12) Patent Application Publication
(10) Pub. No.: US 2003/0100206 A1
(43) Pub. Date: May 29, 2003

(54) Safety device for the supply of power to electrical equipment

(76) Inventors: Carlo Rosa, Lecco (IT); Michele Picchi, Pontedera (IT)

Correspondence Address: LARSON & TAYLOR, PLC, 1199 NORTH FAIRFAX STREET, SUITE 900, ALEXANDRIA, VA, 22314, US

(21) Appl. No.: 10/288,518

(22) Filed: Nov. 6, 2002

(30) Foreign Application Priority Data
Nov. 28, 2001 (IT) GE2001U000032

(51) Int. Cl. H01R 13/44

(52) U.S. Cl. 439/135

(57) ABSTRACT

Safety device for the supply of power to electrical equipment, and particularly to mobile domestic appliances, comprising two electrical connector elements which can be coupled together, of which a first electrical connector element is located on the said electrical equipment and is provided with openable means for covering in a liquid-tight way the portion of the said element to be used for connection, and a second electrical connector element is located at one end of the power supply cable of the said equipment and is provided with openable means for covering in a liquid-tight way the portion of the said element to be used for the connection, means being provided for the mutual locking of the coupling of the said first and second element.

### BACKGROUND AND SUMMARY OF THE INVENTION

The present invention relates to the supply of power to electrical equipment, and in particular relates to a safety device for the supply of power to electrical equipment.

An ordinary commercially available domestic electrical appliance is usually provided with a power supply socket into which is fitted a cable whose other end is designed for connection to the mains. In many cases, this kind of connection between the cable and the appliance can come into contact, even if only accidentally, with water or other liquids; this evidently limits the safety of use of such appliances, with a consequent increase in the risks for the user. This kind of risk is considerably increased in mobile electrical appliances, such as vacuum cleaners, steam cleaning machines and the like. It should also be borne in mind that the actual connection itself can additionally be made liquid-tight, but the elements that are connected together are never protected from the action of external agents.

The object of the present invention is therefore to provide a safety device for the supply of electrical appliances, and particularly mobile domestic appliances, which provides a liquid-tight connection between the equipment and the power supply cable, and which ensures the liquid-tight protection of the elements of the connection even when the connection is not in use.

The present invention is therefore concerned with a safety device for the supply of power to electrical equipment, and particularly to mobile domestic appliances, the device comprising two electrical connector elements which can be coupled together, of which a first electrical connector element is located on the said equipment and is provided with openable means for covering in a liquid-tight way the portion of the said element to be used for connection, while a second electrical connector element is located at one end of the power supply cable of the said equipment and is provided with openable means for covering in a liquid-tight way the portion of the said element to be used for connection, means being provided for the mutual locking of the coupling of the said elements.

### BRIEF DESCRIPTION OF THE DRAWINGS

Further advantages and characteristics of the device according to the present invention will be made clear by the following detailed description of one embodiment of the invention, provided by way of example and without restrictive intent, with reference to the attached sheets of drawings, in which:

FIG. 1 is a lateral elevation, in partial section, of an item of electrical equipment provided with the safety device according to the present invention, shown with the connector elements separated; and

FIG. 2 is a view similar to that of FIG. 1, with the connector elements connected to each other.

### DESCRIPTION OF THE PREFERRED EMBODIMENT OF THE INVENTION

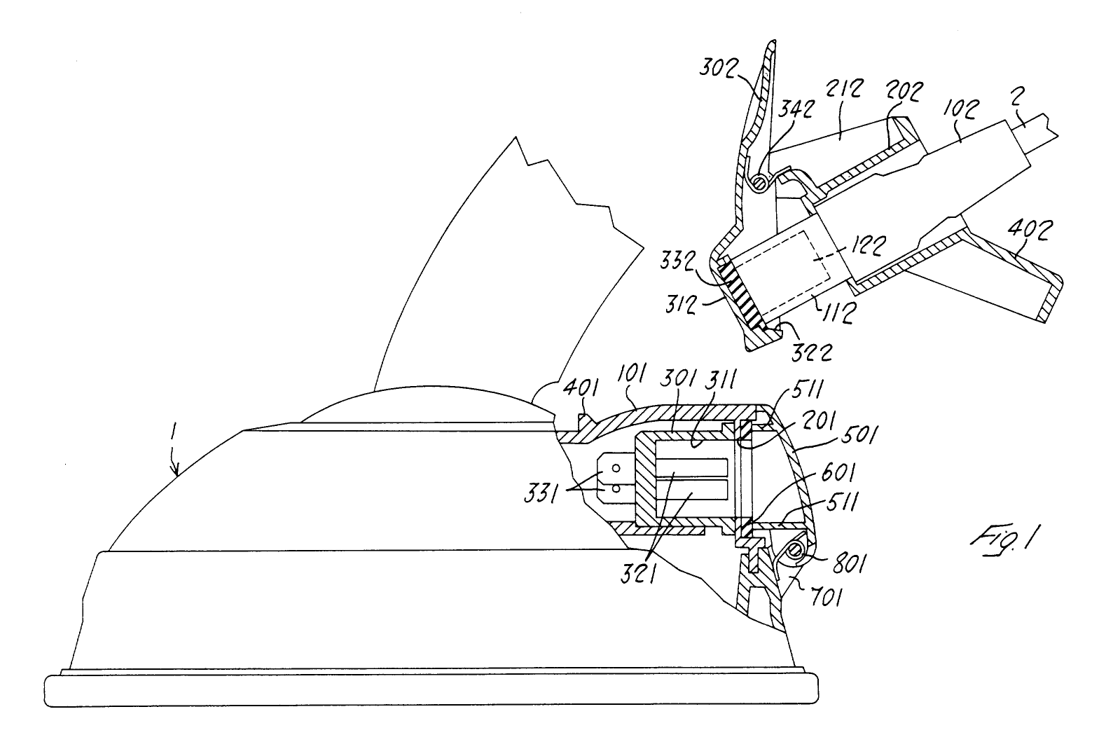

FIG. 1 shows the device according to the present invention; the number 1 indicates the electrical equipment, typically a mobile electrical appliance such as an electric brush, a steam cleaning machine, or the like. The equipment 1 is provided with a box-shaped body 101 in whose wall is formed an aperture 201, next to which is positioned, inside the body 101, a socket 301, connected to the wall of the said body 101. The conductors 321 are arranged inside the cavity 311 of the socket 301, with their ends 331 projecting from the bottom of the socket 301 and pointing towards the electrical appliance (not shown in the figures) which is located inside the equipment 1.

A cover 501, pivoted at one end on strips 701 projecting from the body 101, is positioned on the aperture 201; the connection between the cover 501 and the strips 701 is provided by a spring 801 which can force the said cover to close. The cover 501 is also provided, on its side facing the aperture 201, with an axial flange 511, whose outward edge bears on the sealing element 601 located around the said aperture 201. A projection in the form of a catch 401 projects outwards from the wall of the body 101 in the proximity of the aperture 201.

The number 2 indicates the power supply cable of the equipment, which carries at its end shown in the figure the plug 102, whose contact end 112 is inserted into the cavity 311 of the socket 301; the recess 122 in the contact end 112 is designed to house the conductors 321 of the socket 301. The plug 102 is housed in a box-shaped casing 202, provided on one of its faces with strips 212 projecting perpendicularly to the said face, on which strips there is pivoted a lever 302 which carries at its end a cover 312 for covering the contact end 112 of the plug 102. There are also provided means, in the form of a helical spring 342, for elastically loading the lever 302, and consequently the cover 312, towards the contact end 112. A frontal sealing element 332 is positioned inside the cover 312, while the peripheral edge of the cover 312 has a profile in the form of a catch 322. The face of the casing 202 diametrically opposite the face carrying the strips 212 is provided with an angled counter-element 402, made in one piece with the said casing, the purpose of this element being described more fully below.

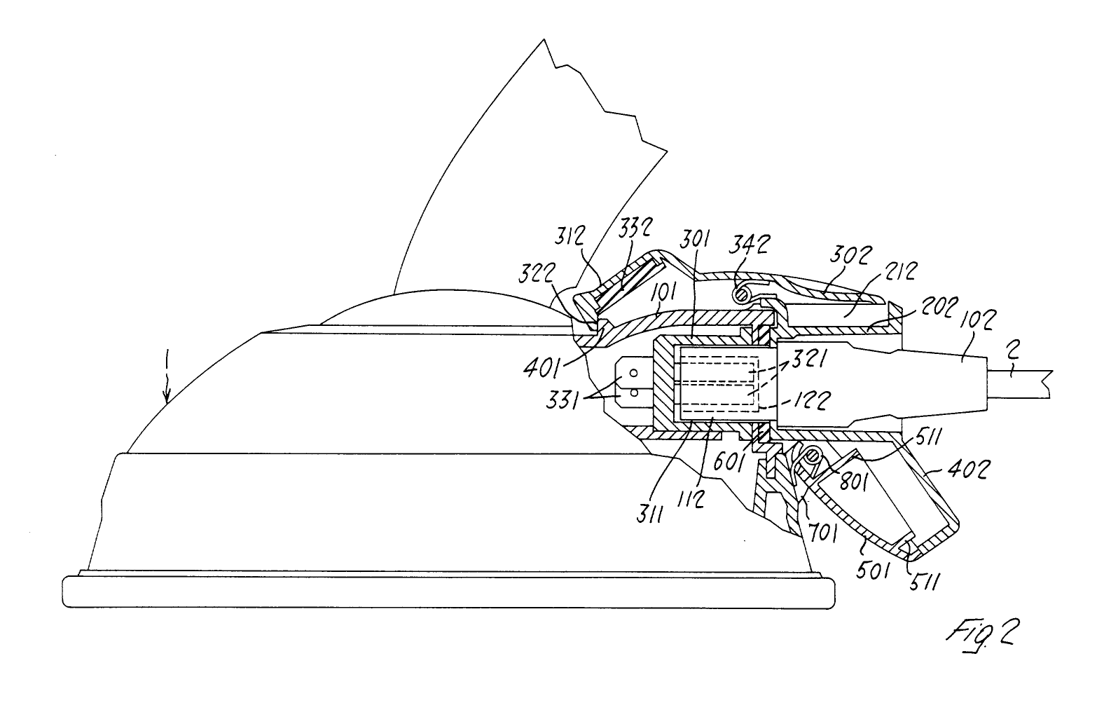

In FIG. 2, the connector elements of the device according to the invention are connected together. The contact end 112 of the plug is inserted into the cavity 311 of the socket 301, and the conductors 321 are positioned inside the recess 122 of the contact end, where the electrical connection is established to provide the power supply to the equipment. The cover 501 of the access aperture 201 of the socket 301 is in the open position, and is kept in this position by the counter-element 402 of the casing 202 of the plug 102. The lever 302 is pushed towards the casing 202, in such a way that the cover 312 allows the contact end 112 to enter the cavity 311 of the socket 301; additionally, the profile in the form of a catch 322 of the outer edge of the said cover 312 interacts with the projection 401 projecting from the box-shaped body 101 of the equipment.

The operation of the safety device according to the present invention will be made clear by the following description. The connector elements, as illustrated in FIG. 1, are both protected in an extremely secure way from any contact with water or other agents which might compromise or in any way make dangerous the connection between the power supply cable and the electrical equipment. The liquid-tight covering of the socket 301 and the plug 102, by the covers 501 and 312 respectively, ensures the protection of the conductors located in the said socket and in the said plug; the effectiveness of the sealing of the said covers is enhanced by the fact that both of them are provided with elastic loading means, in the form of the springs 801 and 342 respectively.

When the user wishes to establish the connection and supply the power to the equipment 1, he has to move the cover 501 downwards to uncover the access aperture 201 of the socket 301, and grasp the plug 102 with his other hand, pushing down the lever 302 connected to the cover 312, in order to expose the contact end 112 of the plug 102. Then, after the contact end 112 of the plug has been inserted into the cavity 311 of the socket 301, and thus after the connection has been established by the insertion of the conductors 321 into the recess 122 of the contact end, the profile in the form of a catch 322 of the outer edge of the cover 312 passes over the projection in the form of a catch 401 projecting from the body 101 of the equipment, so that the connection between the two connector elements is made secure. The cover 501 of the socket 301 is kept in the open position by the counter-element 402 projecting from the casing 202 of the plug 102. The connection established in this way is very stable, and its liquid-tightness is additionally ensured by the interaction established between the edge of the cover 312 and the projection 401 of the body of the equipment. When the connection is broken, the covers of both the connector elements return automatically to the closed position, because of the elastic loading means with which they are provided.

The safety device designed according to the present invention therefore has two essential advantages; on the one hand, it improves the liquid-tightness of the connection between the equipment and the power supply cable, as well as the safety and security of the said connection, while on the other hand it ensures the liquid-tight protection of the connector elements when they are not connected to each other.

We claim:

1. Safety device for the supply of power to electrical equipment, and particularly to mobile domestic appliances, comprising two electrical connector elements which can be coupled together, a first electrical connector element of the device being located on the said electrical equipment and being provided with openable means for covering in a liquid-tight way the portion of the said element to be used for connection, while a second electrical connector element is located at one end of the power supply cable of the said equipment and is provided with openable means for covering in a liquid-tight way the portion of the said element to be used for connection, means being provided for the mutual locking of the coupling of the said first and second element.

2. Safety device according to claim 1, in which the said first connector element comprises a socket, in which are housed the conductors connected to the electrical circuit of the said equipment, located within the body of the said equipment, inside an aperture formed in the said body, the said aperture being provided with a liquid-tight cover, pivoted along one of its sides on the said body of the equipment, the said cover being provided with means of elastically loading it towards the closed position.

3. Safety device according to claim 2, in which an annular sealing element is positioned around the said aperture, the said cover being provided with an axial flange projecting towards the said sealing element and bearing on this element when the cover is in the closed position.

4. Safety device according to claim 3, in which the said second electrical connector element comprises a plug, having at one end a contact end in which are located the means for connection to the conductors of the power supply cable of the said equipment, the said plug being enclosed by a casing on whose end facing the said contact end there is pivoted a liquid-tight cover provided with a lever and means for elastically loading it towards the closed position.

5. Safety device according to claim 4, in which the said casing is provided with a radially projecting counter-element designed to interact with the said cover of the said aperture communicating with the said socket, in such a way as to keep this cover in the open position when the said contact end of the said plug is inserted into the said socket.

6. Safety device according to claim 5, in which the said means of mutually locking the said connector elements comprise a profile in the form of a catch projecting from the outer edge of the cover of the contact end of the said plug of the power supply cable, this profile being designed to interact with a projection in the form of a catch projecting from the body of the said equipment and located in the proximity of the said aperture.
